(19) United States
(12) Patent Application Publication
(10) Pub. No.: US 2020/0081168 A1
(43) Pub. Date: Mar. 12, 2020

(54) REPLICA OPTICAL ELEMENT

(71) Applicant: SHIMADZU CORPORATION, KYOTO-SHI (JP)

(72) Inventors: SATOSHI KURAMOTO, Kyoto-Shi (JP); HIROYUKI SASAI, Kyoto-Shi (JP)

(73) Assignee: SHIMADZU CORPORATION, KYOTO-SHI (JP)

(21) Appl. No.: 16/123,727

(22) Filed: Sep. 6, 2018

(51) Int. Cl. G02B 5/18

(52) U.S. Cl. CPC G02B 5/1852; G02B 2005/1804

(57) ABSTRACT

A replica optical element reduces stray light and is manufactured by the method comprising steps of: forming a mold-releasing agent film, forming a metal film, adhering, by which a top-surface of the metal film and an undersurface of a glass substrate, preparing a reflection optical element, removing the glass substrate from a mold 30 and, if a refractive index relative to D-line of the glass is n1 and a refractive index relative to D-line of the adhesive resin is n2, then a vertical reflectivity R meets a following formula (1).

R=(n₁−n₂)²/(n₁+n₂)²≤1.0×10⁻⁵ (1).

### CROSS REFERENCE TO RELATED APPLICATIONS

This application relates to, but does not claim priority from, JP 2016-050411 filed Mar. 15, 2016 which was published as JP 2017-167231 on Sep. 21, 2017, the entire contents of which are incorporated herein by reference.

### FIGURE SELECTED FOR PUBLICATION

FIG. 1

### BACKGROUND OF THE INVENTION

### Field of the Invention

The present invention relates to a replica optical element applied to a variety of optical instruments, such as a spectrophotometer and particularly, relates to a replica diffraction grating that is mounted in a spectrograph in which a setting angle thereof is fixed.

### Description of the Related Art

Conventionally, when a diffraction grating is subject to a mass production, a method by which a replica diffraction grating is produced using a master diffraction grating (White and Fraser Replication Method) (e.g., Patent Document 1).

According to the White and Fraser replication method (e.g., refer to U.S. Pat. No. 2,464,738; 1949), first, a master metal thin film is formed on the top-surface of the master substrate (glass substrate) by evaporating (depositing) a metal such as aluminum and a master diffraction grating is produced by forming a grating groove on such a master metal film. Next, the master diffraction grating is used as a master mold (matrix), and an oil film (mold releasing agent film) is thinly formed on a top-surface of the grating surface (forming a master metal thin film), a replica metal thin film is then formed on the top-surface of the oil film by vacuum evaporation, and then a replica thin film is formed having the grating groove form. Next, the replica substrate (glass substrate) contacts with the top surface of the replica metal film via an adhesive in-between and, after the adhesive is solidified, the replica substrate is separated from the master mold (grating). In such a way, the replica metal thin film formed on the top surface of the oil film is pried apart to provide the replica reflective diffraction grating.

In addition, a wet etching process using such as sodium hydroxide (sodium soda) is carried out to dissolve the replica metal thin film to provide the replica transmissive diffraction grating.

And such a replica reflective diffraction grating and a replica transmissive diffraction grating are mainly applied to a spectrograph.

### RELATED PRIOR ART DOCUMENTS

### Patent Document

### Patent Document 1

### JPH 7-261010 A1

### ASPECTS AND SUMMARY OF THE INVENTION

### Objects to be Solved

Whereas an absorption intensity of an incident monochromatic light, of which wavelength is separated by the replica transmissive diffraction grating, into a sample is measured when a sample is analyzed using a spectrum mode of the spectrograph, but given light having a wavelength other than the monochromatic light, i.e., stray light, contaminates the incidence, such contamination as a noise is a factor that deteriorates the analytical sensitivity and the analytical precision. Such a stray light is not a serious concern when the wavelength of the light applied is relatively long, i.e., infrared light or visible light, but when the wavelength of the light applied is light having a short wavelength, e.g., such as a soft X-ray, the stray light is problematic.

### Means of Solving the Problem

The present inventors have conducted an extensive study as to a replica optical element that reduced an occurrence of the stray light.

Now, the refractive index m of the replica base, BK7 (a kind of synthetic quartz) is 1.518 (D-line of sodium) and the refractive index n₂ of the adhesive resin is 1.56 (D-line), so that the irradiated light reflects at the interface between the replica substrate and the adhesive resin layer and the reflected-scattered light (diffuse reflection light) emitted in the same direction as the normal diffracted light is the stray light. Based on such a fact, when the vertical reflectivity R relative to the D-line is 2×10⁻⁴, it is found that the stray light causes a problem.

In addition, the replica substrate of which the coating surface for the adhesive is the ground surface, which is a fine convex-concave surface, is used to increase the adhesion area so that the adhesivity between the replica substrate and the adhesive improves. Whereas such a ground surface causes the stray light. Based on the study, it is found that when the plane roughness S is 14 μm Rms (root-mean-square), the stray light causes the problem.

Specifically, a replica optical element of the present invention is manufactured by the method comprising steps of: forming a mold-releasing agent film, by which a grooved mold-releasing agent film is formed on a groove surface of the mold; forming a metal film, by which a grooved metal film is formed on the mold-releasing film; adhering, by which a top-surface of the metal film and an undersurface of the glass substrate tightly adhere via an adhesion resin; preparing a reflection optical element, by which a replica optical element in which an adhesive resin layer and the metal film adhere on the glass substrate is prepared by removing the glass substrate from the mold; wherein if a refractive index relative to D-line of the glass is n₁ and a refractive index relative to D-line of the adhesive resin is n₂, a vertical reflectivity R meets the following formula (1).

R=(n₁−n₂)²/(n₁+n₂)²≤1.0×10⁻⁵ (1)

In addition, the present invention includes the case in which the up-and-down direction is reversed.

### Effect of the Invention

As set forth above, with respect to the replica optical element of the present invention, the vertical reflectivity R meets the formula (1), so that the reflection light and the scattering light decrease and as a result, the stray light also decreases. In addition, the spectrograph using such a replica optical element improves the analytical precision and the analytical sensitivity and particularly, the analytical precision relative to the short wavelength region such as soft X-ray largely improves with contribution thereof.

### Means to Solve Other Problems and Effects Thereof

In addition, the plane roughness S of the undersurface of the glass substrate relative to the replica optical element of the present invention may meet the following formula (2).

S≤1.0 (nm Rms) (2)

With respect to the replica optical element of the present invention, the plane roughness S meets the formula (2), so that the reflection light and the scattering light decrease and as a result, the stray light also decreases.

In addition, with respect to the replica optical element of the present invention, the adhesive resin may contain a coupling agent.

With respect to the replica optical element of the present invention, for example, a coupling agent, represented by e.g., a silane coupling agent that improves the affinity (compatibility) between an organic component and an inorganic component, is mixed in an adhesive resin, so that even if the adhesive surface of the replica substrate is a glossy surface, i.e., not ground surface, a high-adhesivity is ensured and as a result, the metal film adheres firmly to the replica substrate.

In addition, with respect to the replica optical element of the present invention, the step of adhering may comprise coating the coupling agent on the undersurface of the glass substrate prior to adherence of the top surface of the metal film and the undersurface of the glass substrate via the adhesive resin.

With respect to the replica optical element of the present invention, the coupling agent is coated on the glossy adhesive surface of the replica substrate and then, the adhesive resin is overcoated or piled thereon to enhance the adhesivity of the coupling agent, so that the metal film adheres firmly to the replica substrate.

And the replica transmissive optical element is prepared from the adhesive resin layer having a groove surface and the glass substrate by removing the metal film from the replica reflection optical element.

In addition, with respect to the replica optical element of the present invention, the mold is the master diffraction grating or the negative diffraction grating, and the replica optical element may be a replica diffraction grating.

The above and other aspects, features and advantages of the present invention will become apparent from the following description read in conjunction with the accompanying drawings, in which like reference numerals designate the same elements.

### BRIEF DESCRIPTION OF THE DRAWINGS

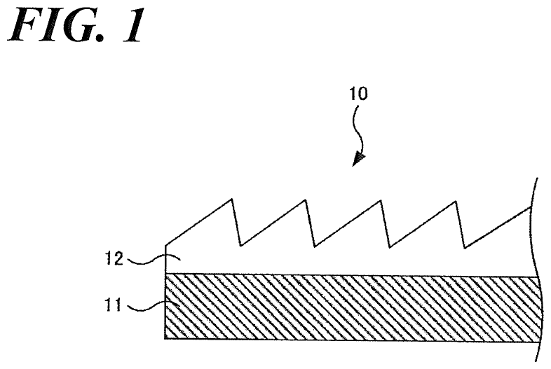

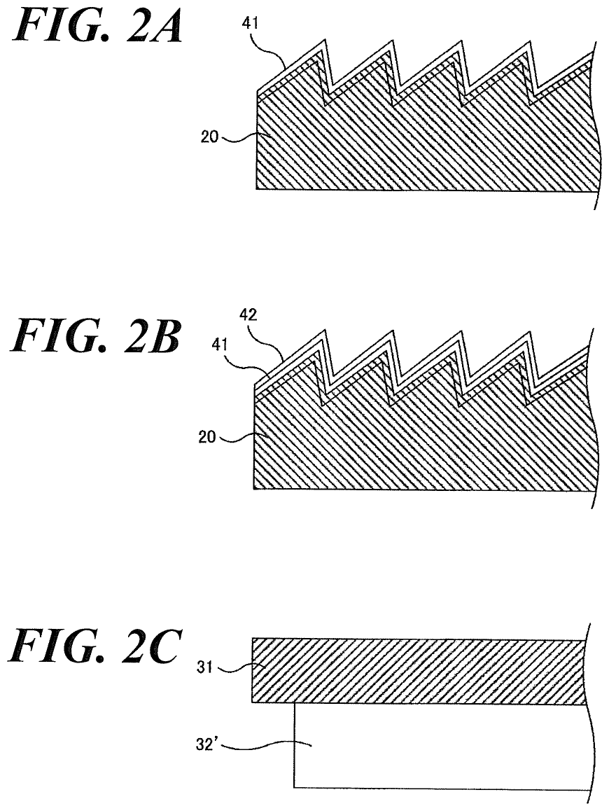

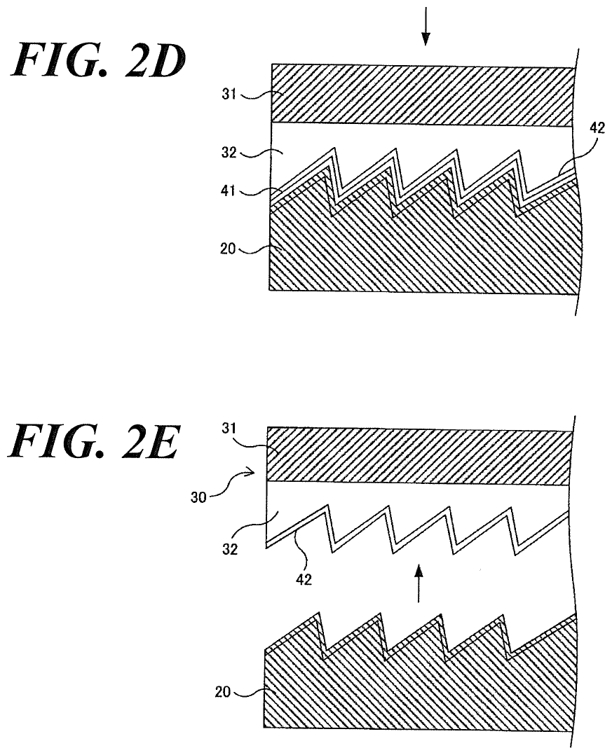

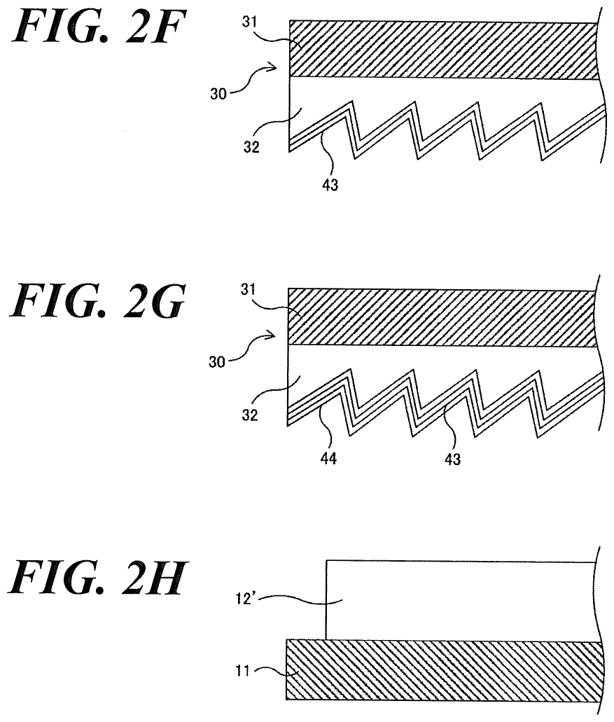

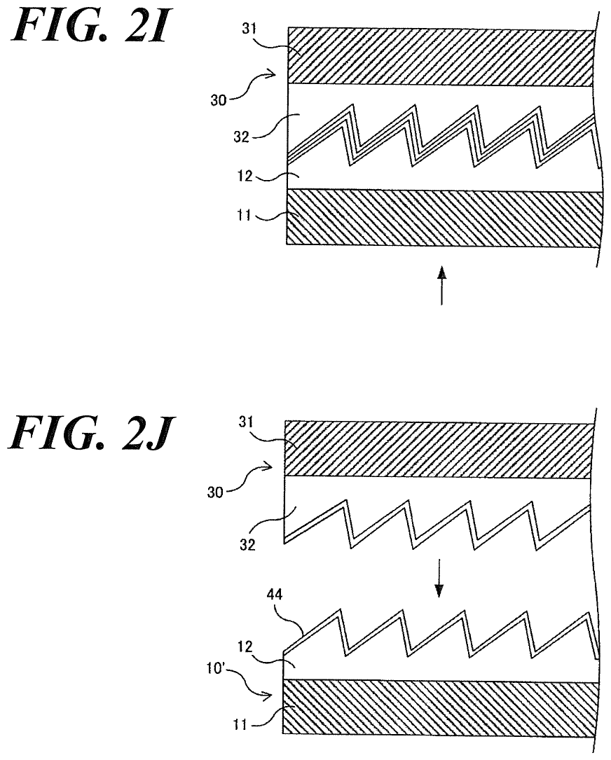

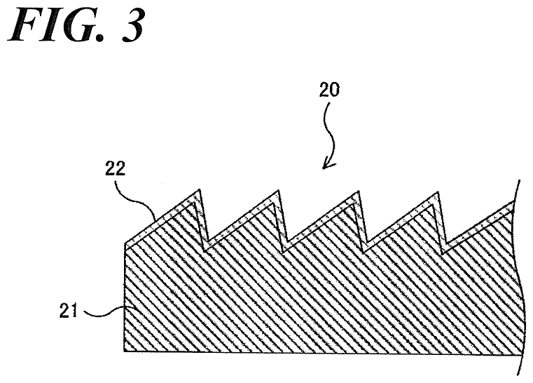

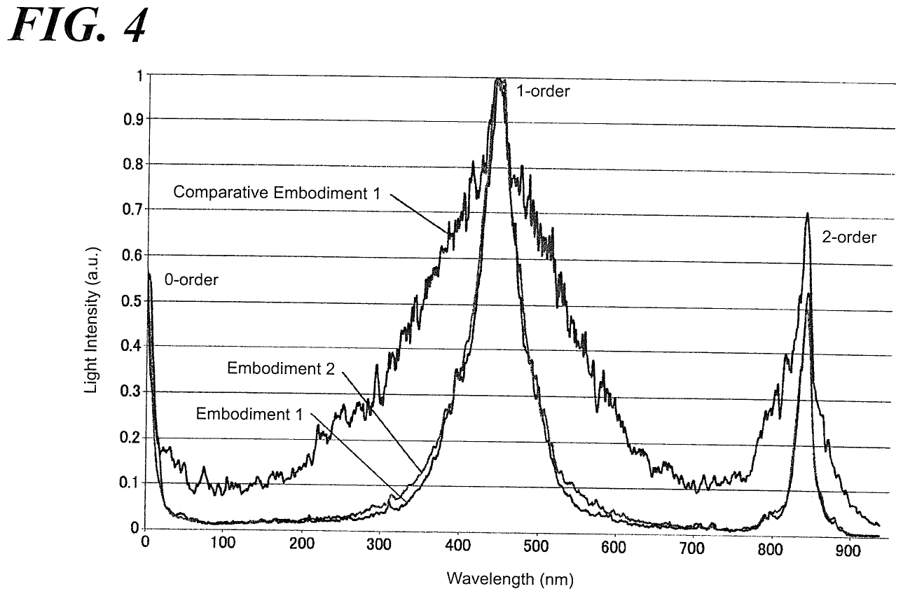

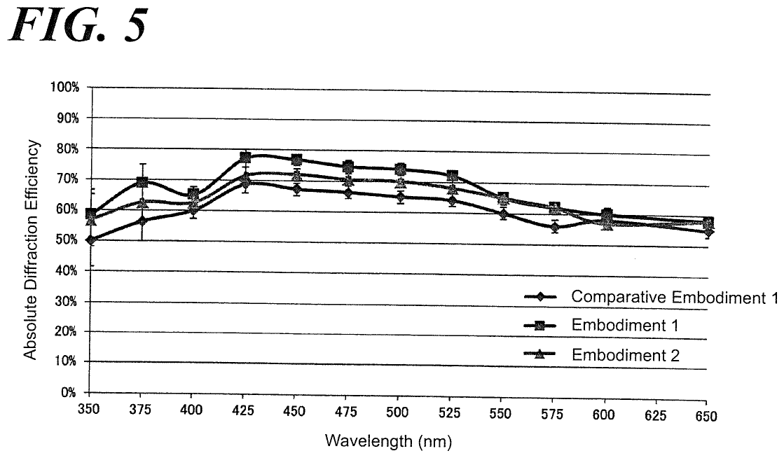

FIG. 1 is a cross-section view illustrating an Embodiment of the replica transmissive diffraction grating according to the aspect of the present invention.

FIG. 2A, FIG. 2B, FIG. 2C are explanatory views illustrating a manufacturing method of the replica transmissive diffraction grating according to the aspect of the present invention.

FIG. 2D, FIG. 2E are explanatory views illustrating a manufacturing method of the replica transmissive diffraction grating according to the aspect of the present invention.

FIG. 2F, FIG. 2G, FIG. 2H are explanatory views illustrating a manufacturing method of the replica transmissive diffraction grating according to the aspect of the present invention.

FIG. 2I, FIG. 2J are explanatory views illustrating a manufacturing method of the replica transmissive diffraction grating according to the aspect of the present invention.

FIG. 3 is a cross-section view illustrating a master diffraction grating.

FIG. 4 is a graph illustrating the relationship between the wavelength of diffraction light and the light intensity thereof.

FIG. 5 is a graph illustrating the absolute diffraction efficiency.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art.

Hereinafter, the inventors set forth the Embodiments of the present invention referring to FIGS. It will be apparent to those skills that the invention is not limited to those embodiments described below, and that various modifications and variations can be made in a variety of aspects without departing from the scope or spirit of the invention.

FIG. 1 is a cross-section view illustrating an Embodiment of the replica transmissive diffraction grating according to the aspect of the present invention.

The replica transmissive diffraction grating 10 comprises the replica substrate 11 and the adhesive resin layer 12.

The replica substrate 11 has six surfaces including the top surface, the undersurface, the front surface, the rear surface, the right-side surface and the left-side surface, and e.g., is a flat plate having 11 mm thickness, 60 mm length from front edge to back edge, and 60 mm width from right edge to the left edge.

The plane roughness S of the above replica substrate is preferable at most 1.0 (nm Rms) and more preferable at most 0.5 (nm Rms). In addition, it is preferable that the undersurface of the above replica substrate is coated with AR-coating (anti-reflection coating) (400 nm center wavelength) of e.g., MgF₂ having a predetermined thickness (e.g., 70 nm) and so forth.

The adhesive resin layer 12 is formed on the top surface of the replica substrate 11 and the grating groove (e.g., serration having 200/mm grooves, blaze angle 8.6°) is formed on the top surface (grating surface) of the adhesive resin layer 12.

The material for the replica substrate is e.g., a low-expansion crystal glass such as quartz glass, Zerodur® (a trademark and available from e.g., Schott Japan Corporation), BK7, Pyrex® glass (a trademark and available from Corning Corporation), soda glass and so forth.

In addition, the material for the above adhesive resin layer is a thermoset resin e.g., a urea-formaldehyde resin, a melamine formaldehyde resin, a phenol resin, and an epoxy resin, and a ultraviolet cure resin and so forth.

In addition, if the refractive index relative to (sodium) D-line of the material from the replica substrate 11 is n₁ and the refractive index relative to D-line of the adhesive resin 12 is n₂, the vertical reflectivity R meets a formula (1).

R=(n₁−n₂)²/(n₁+n₂)²≤1.0×10⁻⁵ (1)

Specifically, it is preferable that the vertical reflectivity R is at most 1.0×10⁻⁵ and more preferably, at most 4×10⁻⁷.

Here referring to FIG. 2A-FIG. 2J, the inventors set forth one Embodiment relative to the manufacturing method of the replica transmissive diffraction grating 10 according to the aspect of the present invention. The manufacturing method thereof comprises steps of: preparing the master diffraction grating (A-1); forming the mold releasing agent film (B-1); forming the metal film (B-2); adhering (B-3); preparing the negative diffraction grating (B-4); forming the mold releasing film (C-1); forming the replica metal film (C-2); adhering (C-3); preparing the reflection diffraction grating (C-4) and preparing the transmissive diffraction grating (C-5).

(A-1) Step of Preparing the Master Diffraction Grating:

First, prepare the master diffraction grating 20. FIG. 3 is a cross-section view illustrating the master diffraction grating. The master diffraction grating 20 comprises the master substrate 21 and the master metal thin film 22.

The master substrate 21 has six surfaces including the top surface, the undersurface, the front surface, the rear surface, the right-side surface and the left-side surface, and the grating groove (e.g., serration having 200/mm grooves, blaze angle 8.6°) is formed on the top surface of the master substrate 21.

In addition, the material for the master substrate is the same as the replica substrate, e.g., a low-expansion crystal glass such as quartz glass, Zerodur® (a trademark and available from e.g., Schott Japan Corporation), BK7, Pyrex® glass (a trademark and available from the Corning Corporation), soda glass and so forth above.

The master metal thin film 22 is formed on the top surface (grating surface) of the master substrate 21 so as to provide a predetermined thickness. Specifically, the master metal thin film 22 appears as a grating groove.

Thickness of the above master metal thin film 22 is preferably in the range of 0.1 μm to 2 μm, and the material for the above master metal thin film 22 is such as aluminum, gold, platinum, chrome, Nichrome® (a trademark available from the Driver-Harris Wire Company, and others referring to a high temperature alloy wire), and nickel.

The inventors set forth one example of manufacturing methods of a master diffraction grating 20, wherein first, coat the 60 mm×60 mm×11 mm of glass substrate 21 with 0.4 μm thickness of OFPR® 5000 (a trademark, and available from Tokyo Ohka Kogyo Co., Ltd.) as a photoresist (light-sensitive resist film), expose the resist pattern of the grating groove (density 200/mm) using the holographic exposure method (laser wavelength 441.6 nm) to the photoresist, and immerse the photoresist in the developer for an adequate period of time, and then after, form the resist patter. Next, form the grating groove, of which groove cross-section appears as a serration having the blaze angle 8.6°, by anisotropic ion-beam etching, in which such a resist pattern is a mask. Next, form the film thickness 0.2 μm of the master metal thin film 22 on the grating groove by vacuum deposition. In such way, complete the manufacturing of the master diffraction grating 20. In addition, the marked line is either the machining marked line using the grating engraving apparatus or the marked line using an ion-beam etching.

(B-1) Step of Forming the Mold-Releasing Agent Film (Referring to FIG. 2A).

Form the oil film (mold releasing agent film) 41 on the grating surface of the master grating 20 so as to provide the predetermined thickness.

Such as a vacuum deposition method is applicable to the above oil film forming method, and when applying the vacuum deposition method, it is preferable that the grating surface is subject to e.g., an orbital rotation or a ‘sun-and-planet’ rotation (orbital rotation+spin rotation) while keeping the constant distance from the vacuum deposition source so as to uniformly form the film on the grating surface. In addition, it is preferable that the above predetermined film thickness in the range of 4 nm to 10 nm, and the material for such a film is e.g., silicone oil and so forth.

(B-2) Step of Forming a Metal Film (Referring to FIG. 2B)

Form the metal thin film 42 on the oil film 41 so as to provide the predetermined thickness. Specifically, the negative metal thin film 42 appears as a grating groove.

Such as the above vacuum deposition method is applicable to the metal thin file forming method. In addition, the predetermined thickness of the above negative metal thin film 42 is preferably in the range of 0.1 μm to 2 μm, and the material for the above metal thin film 42 is such as aluminum, gold, platinum, chrome, Nichrome® and nickel.

(B-3) Step of Adhering

Prepare the flat float glass plate 31, coat the undersurface of the float glass 31 to form an adhesive resin layer 32′ (referring to FIG. 2C). Next, press down the float glass plate 31 toward the negative metal thin film 42 with an adequate force via the adhesive resin layer 32′ (referring to FIG. 2D). At this time, the adhesive resin layer 32′ spreads as filling the grating groove of the metal thin film 42, of which the cross-section appears as a serration, so that the adhesive resin layer 32 having the grating groove on the undersurface thereof is made. Next, place the adhesive resin layer 32 in the baking furnace and conduct curing by heating for approximately 24 hours at 60° C. or irradiating UV light to the adhesive resin layer 32.

It is preferable that the plane roughness S of the undersurface of the above float glass plate is the level as the ground surface, and the material for the above adhesive resin layer is a thermoset resin e.g., a urea-formaldehyde resin, a melamine formaldehyde resin, a phenol resin, and an epoxy resin, and a ultraviolet cure resin and so forth.

(B-4) Step of Preparing the Negative Diffraction Grating (Referring to FIG. 2E)

Remove the float glass plate 31 upward from the master diffraction grating 20, and remove the negative metal thin film 42 and the adhesive resin layer 32 having the oil film (mold releasing agent film) 41 in-between thereof together with the float glass plate 31. In addition, clean and remove the left-over oil film 41 on the undersurface of the metal thin film 42 using such as a fluorine solvent (for example AK-255, a product available from AGC Inc.).

As a result, the negative grating 30, in which the adhesive resin layer 32 and the negative metal thin film 42 adhere to the float glass plate 31, is prepared.

(C-1) Step of Forming the Mold-Releasing Agent Film (Referring to FIG. 2F)

Form the oil film (mold releasing agent film) 43 on the grating surface of the negative grating 30 so as to provide the predetermined thickness.

As a method of forming the above oil film, the vacuum deposition method as set forth above is applicable. In addition, it is preferable that the above predetermined thickness of the oil film is in the range of 4 nm to 10 nm, and the material for such an oil film is e.g., silicone oil and so forth.

(C-2) Step of Forming the Replica Metal Film (Referring to FIG. 2G)

Form the replica metal thin film 44 on the oil film 43 so as to provide the predetermined thickness. Specifically, the replica metal thin film 44 appears as a grating groove.

As a method of forming the above replica metal thin film 44, the vacuum deposition method as set forth above is applicable. In addition, the predetermined thickness of the above replica metal thin film 44 is preferably in the range of 0.1 μm to 2 μm, and the material for the above metal thin film 42 is such as aluminum, gold, platinum, chrome, Nichrome® and nickel.

(C-3) Step of Adhering

Prepare the replica substrate 11, grind the top surface of the replica substrate 11 to provide the predetermined plane roughness S and clean such a surface with such as fluorine solvent, and then after, coat the top surface of the replica substrate 11 with the adhesive resin to form the adhesive resin layer 12′ (referring to FIG. 2H).

As the grinding method of the top surface of the above replica substrate 11, such as double-side lap grinding processing is applicable.

In such a case, it is preferable that the adhesive resin contains the coupling agent in the adhesive layer or coat the coupling agent on the top surface of the replica substrate 11 prior to coating the adhesive resin on the top surface of the replica substrate 11.

The above coupling agent acts a binder between an organic material and an inorganic material, and for example, includes such as silane coupling agent, and the specific useful example of such as silane coupling agent includes 3-glycidoxypropyltrimethoxysilane (e.g., an example supply is KBM-403 which is available from Shin-Etsu Chemical Co., Ltd.).

And press down the replica substrate 11 to the replica metal thin film 44 with an adequate force via the adhesive resin layer 12′ (referring to FIG. 2I). At this time, the adhesive resin layer 12′ spreads as filling the grating groove of the metal thin film 44, of which the cross-section appears as a serration, so that the adhesive resin layer 12 having the grating groove on the top surface thereof is made. Next, place the adhesive resin layer 12 in the baking furnace and conduct curing by heating for approximately 24 hours at 60° C. or irradiating UV light to the adhesive resin layer 12.

(C-4) Step of Preparing the Reflection Diffraction Grating (Referring to FIG. 2J)

Remove the replica substrate 11 downwardly from the negative diffraction grating 30, and remove the replica metal thin film 44 and the adhesive resin layer 12 having the oil film (mold releasing agent film) 44 in-between thereof together with the replica substrate 11. In addition, clean-and-remove the left-over oil film 43 from the top surface of the replica metal thin film 44 using such as a fluorine solvent.

As a result, the replica reflection grating 10′, in which the adhesive resin layer 12 and the replica metal thin film 44 adhere to the replica substrate 11, is prepared.

(C-5) Step of Preparing the Transmissive Diffraction Grating

Immerse the replica reflection grating 10′ in the sodium hydroxide (sodium soda) solution to dissolve the replica metal thin film 44, and then after, take out the replica reflection grating 10′ from the sodium soda solution and rinse the replica reflection grating 10′ with purified water, and then dry the replica reflection grating 10′ with such as a spinner. In such a way, the replica transmissive diffraction grating 10 (referring to FIG. 1) comprising the replica substrate 11 and the adhesive resin layer 12 having the grating surface is prepared.

As set forth above, with respect to the replica transmissive diffraction grating 10 of the present invention, the vertical reflectivity R meets the formula (1), so that the reflection light and the scattering light decrease and as a result, the stray light also decreases.

### Other Embodiments

In addition, the present invention is applicable to e.g., such as a non-spherical optical replica element, a spherical optical replica element and a plane optical replica element.

### Embodiments

Hereinafter, the inventors set forth further specifically according to the Embodiment, but the invention may not be limited thereto.

### Embodiment 1

According to the manufacturing method as set forth above, the replica transmissive diffraction grating, according to the aspect of the Embodiment 1, comprising the serrate grating surface having 200/mm grooves and blaze angle 8.6° is prepared using a flat plane replica substrate (N-SK11 a brand and a type of material available from the Schott Japan Corporation) having 11 mm thickness, 60 mm length from front to rear, and 60 mm width from right to left, of which plane roughness S is 1 nm Rms, the refractive index n₁ of the material is 1.562 (D-line), and using the adhesive resin having the refractive index n₂ of the adhesive resin that is 1.56 (D-line). In addition, the vertical reflectivity R is 4×10⁻⁷.

### Embodiment 2

The replica transmissive diffraction grating, according to the aspect of the Embodiment 2, is prepared as well as the Embodiment 1, but the replica substrate having 14 μm Rms of the plane roughness S instead of the replica substrate having 1 nm Rms of the plane roughness S. In addition, the vertical reflectivity R is 4×10−7.

### Comparative Embodiment 1

The replica transmissive diffraction grating, according to the aspect of the comparative Embodiment 1, is prepared as well as the Embodiment 1, but the replica substrate having 14 μm Rms of the plane roughness S and 1.562 (D-line) of the material refractive index n₁ instead of the replica substrate having 1 nm Rms of the plane roughness S and 1.518 (D-line) of the material refractive index n₂. In addition, the vertical reflectivity R is 2×10⁴.

<Evaluation 1> Diffraction Light Intensity

Irradiate the light to the undersurface of the replica transmissive diffraction grating according to the Embodiment 1, 2 and the comparative Embodiment 1, and detect the diffraction light emitted from the top surface. FIG. 4 is a graph illustrating the relationship between the wavelength of diffraction light and the light intensity thereof.

Referring to FIG. 4, the diffraction light due to the replica transmissive diffraction grating according to the comparative Embodiment 1 is broad with many stray lights, whereas the diffraction lights due to the replica transmissive diffraction grating according to the Embodiment 1, 2 are providing a sharp peak shape without significant stray lights. Specifically, the stray lights of the replica transmissive diffraction grating according to the aspect of the Embodiment 1, 2 is approximately one-tenth ( 1/10) of the replica transmissive diffraction grating according to the aspect of the comparative Embodiment 1.

<Evaluation 2> Absolute Diffraction Efficiency (Ratio Between the Incident Intensity and the Intensity of the One-Order Diffraction Light)

Irradiate the light to the undersurface of the replica transmissive diffraction grating according to the Embodiment 1, 2 and the comparative Embodiment 1, and detect the diffraction light emitted from the top surface. FIG. 5 is a graph illustrating the absolute differentiation efficiency.

Referring to FIG. 5, each absolute diffraction efficiency increases in order of the replica transmissive diffraction grating according to the aspect of the comparative Embodiment 1, the replica transmissive diffraction grating according to the aspect of the Embodiment 2 and the replica transmissive diffraction grating according to the aspect of the Embodiment 1. Specifically, the absolute diffraction efficiency of the replica transmissive diffraction grating according to the aspect of the Embodiment 1, 2 improves approximately 10% better than the replica transmissive diffraction grating according to the aspect of the comparative Embodiment 1.

### INDUSTRIAL APPLICABILITY

The present invention is applicable to a variety of replica optical elements being used in a variety of optical instrumentations including such as a spectrophotometer.

### REFERENCE OF SIGNS

10 Replica transmissive diffraction grating
10′ Replica reflection diffraction grating
11 Replica substrate 11 (glass substrate)
12 Adhesive resin layer
20 Master diffraction grating
30 Negative diffraction grating
41 Oil film (Mold release agent film)
43 Oil film (Mold release agent film)
44 Replica metal thin film (metal film)

Skilled artisans may implement the described functionality in varying ways for each particular application, but such implementation decisions should not be interpreted as causing a departure from the scope of the exemplary embodiments.

Also, the inventors intend that only those claims which use the words “means for” are intended to be interpreted under 35 USC 112 only when the phrase ‘for’ is included with the word ‘means’. Moreover, no limitations from the specification are intended to be read into any claims, unless those limitations are expressly included in the claims.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A replica optical element, manufactured by a method, the method comprising steps of:
providing a groove surface of a mold for an optical element;
forming a mold-releasing agent film, as a grooved mold-releasing agent film, on said groove surface of said mold;
forming a metal film, as a grooved metal film, on said mold-releasing film;
said metal film having a top-surface;
providing a glass substrate having an underside surface;
adhering by an adhesive resin, said top-surface of said metal film and said undersurface of a glass substrate;
preparing a replica reflection optical element as said replica optical element, by a first step of removing said glass substrate from said mold and a second step of removing said adhesive resin layer and said metal film from said mold; and
wherein if a refractive index relative to a sodium D-line of said glass substrate is n₁ and a refractive index relative to a sodium D-line of said adhesive resin is n₂, a vertical reflectivity R meets a following formula (1).
R=(n₁−n₂)²/(n₁+n₂)²≤1.0×10⁻⁵ (1)

2. The replica optical element, according to claim 1, wherein:
a plane roughness S of said glass substrate meets a following formula (2).
S≤1.0 (nm Rms) (2)

3. The replica optical element, according to claim 2, wherein:
said adhesive resin contains a coupling agent.

4. The replica optical element, according to claim 2, wherein:
prior to said step of adhering by adhesive resin;
conducting a first step of coating a coupling agent onto said underside surface of said glass substrate.

5. The replica optical element, according to claim 1, further comprising the steps of:
forming a transmissive optical element by conducting a step of removing said adhesive resin layer from from said metal film of said replica reflection optical element.

6. The replica optical element, according to claim 1, wherein:
said mold is at least one grating selected from a group consisting of a master diffraction grating and a negative grating; and
said replica optical element is said replica grating.
